(19) United States
(12) Patent Application Publication
(10) Pub. No.: US 2023/0135162 A1
(43) Pub. Date: May 4, 2023

(54) METHOD AND SYSTEM FOR DATA-DRIVEN FINANCIAL PLANNING

(71) Applicant: JPMorgan Chase Bank, N.A., New York, NY (US)

(72) Inventors: Naftali Y. COHEN, New York, NY (US); Maria Manuela VELOSO, New York, NY (US); Kassiani PAPASOTIRIOU, New York, NY (US); Saheed OBITAYO, New York, NY (US); Tucker Richard BALCH, Suwanee, GA (US); Daniel BORRAJO, Pozuelo de Alarcon, NY (US)

(73) Assignee: JPMorgan Chase Bank, N.A., New York, NY (US)

(21) Appl. No.: 17/454,375

(22) Filed: Nov. 10, 2021

(30) Foreign Application Priority Data
Oct. 29, 2021 (GR) 20210100746

(51) Int. Cl. G06Q 40/06; G06Q 40/02

(52) U.S. Cl. CPC G06Q 40/06; G06Q 40/025

(57) ABSTRACT

A method for providing a data-driven tool for individualized financial planning is provided. The method includes: receiving first information that relates to a user, the first information including at least one financial goal of the user; applying, to the first information, a machine learning algorithm that is uses historical data that relates to financial outcomes; calculating, based on an output of the machine learning algorithm, a probability that the at least one financial goal of the user is achievable; and determining, based on an output the machine learning algorithm, a proposed sequence of actions to be taken by the user with respect to achieving the at least one financial goal. The method may further include applying an artificial intelligence (AI) algorithm that uses a Monte Carlo tree search (MCTS) technique with respect to potential user actions.

### CROSS-REFERENCE TO RELATED APPLICATIONS

This application claims priority benefit from Greek Application No. 20210100746, filed Oct. 29, 2021, which is hereby incorporated by reference in its entirety.

### BACKGROUND

### 1. Field of the Disclosure

This technology generally relates to methods and systems for financial planning, and more particularly to methods and systems for providing a data-driven tool for individualized financial planning and navigation

### 2. Background Information

One service that is generally provided by large financial institutions, such as banks, is financial planning advice. In many situations, such advice is typically based on conventional textbook-style philosophies that are broadly applicable to large classes of customers, while also taking into account risk factors that each particular customer may weigh.

Recently, as a result of increases in computer processing power and speed, it has become more feasible to use large volumes of data to provide fact-based analysis of a variety of situations. Such a use of historical data has not been applied in conventional financial planning scenarios.

Accordingly, there is a need for a mechanism for providing a data-driven approach for individualized financial planning and navigation.

### SUMMARY

The present disclosure, through one or more of its various aspects, embodiments, and/or specific features or sub-components, provides, inter alia, various systems, servers, devices, methods, media, programs, and platforms for providing a data-driven tool for individualized financial planning and navigation.

According to an aspect of the present disclosure, a method for providing a data-driven tool for individualized financial planning is provided. The method is implemented by at least one processor. The method includes: receiving, by the at least one processor from a user, first information that relates to the user, the first information including at least one financial goal of the user; applying, to the first information by the at least one processor, a machine learning algorithm that uses historical data that relates to financial outcomes; determining, by the at least one processor based on a result of the applying of the machine learning algorithm to the first information, at least one proposed sequence of actions to be taken by the user with respect to achieving the at least one financial goal; and calculating, by the at least one processor based on a result of the applying of the machine learning algorithm to the first information, a probability that the at least one financial goal of the user is achievable.

The first information may further include at least one from among an age of the user, an education level of the user, a periodic income of the user, a non-periodic income of the user, a residence location, a periodic amount of discretionary spending, a periodic amount of non-discretionary spending, an outstanding loans amount, and a current savings amount.

The at least one financial goal may include at least one from among a change in an amount of income by a first projected date, a change in an amount of discretionary spending by a second projected date, a change in an amount of non-discretionary spending by a third projected date, a change in an amount of savings by a fourth projected date, a proposed purchase by a fifth projected date, and a proposed life event by a sixth projected date.

The at least one proposed sequence of actions may include at least one from among an income increase, an income decrease, a change in an amount of discretionary spending, a change in an amount of non-discretionary spending, an investment recommendation, and an obtaining of a loan.

The determining of the at least one proposed sequence of actions to be taken by the user may include determining at least two sequences of proposed actions to be taken by the user. The calculating of the probability that the at least one financial goal is achievable may include calculating a respective probability that the at least one financial goal is achievable based on the at least two sequences.

The method may further include displaying, by the at least one processor on a user interface, a result of the calculating of the probability that the at least one financial goal is achievable and a result of the determining of the at least one proposed sequence of actions to be taken by the user.

The method may further include: displaying, by the at least one processor on the user interface, a menu that includes a plurality of alternative financial goals; receiving, by the at least one processor from the user, at least one input that corresponds to a selection of at least one alternative financial goal from among the plurality of alternative financial goals; determining, by the at least one processor based on a result of the applying of the machine learning algorithm to the first information, at least one proposed sequence of actions to be taken by the user with respect to achieving the at least one alternative financial goal; calculating, by the at least one processor based on a result of the applying of the machine learning algorithm to the first information, a probability that the at least one alternative financial goal of the user is achievable; and displaying, on the user interface by the at least one processor, a respective result of each of the calculating and the determining with respect to the at least one alternative financial goal.

According to another aspect of the present disclosure, a computing apparatus for providing a data-driven tool for individualized financial planning is provided. The computing apparatus includes a processor; a memory; a display; and a communication interface coupled to each of the processor, the memory, and the display. The processor is configured to: receive, from a user via the communication interface, first information that relates to the user, the first information including at least one financial goal of the user; apply, to the first information, a machine learning algorithm that uses historical data that relates to financial outcomes; determine, based on a result of the application of the machine learning algorithm to the first information, at least one proposed sequence of actions to be taken by the user with respect to achieving the at least one financial goal; and calculate, based on a result of the application of the machine learning algorithm to the first information, a probability that the at least one financial goal of the user is achievable.

The first information may further include at least one from among an age of the user, an education level of the user, a periodic income of the user, a non-periodic income of the user, a residence location, a periodic amount of discretionary spending, a periodic amount of non-discretionary spending, an outstanding loans amount, and a current savings amount.

The at least one financial goal may include at least one from among a change in an amount of income by a first projected date, a change in an amount of discretionary spending by a second projected date, a change in an amount of non-discretionary spending by a third projected date, a change in an amount of savings by a fourth projected date, a proposed purchase by a fifth projected date, and a proposed life event by a sixth projected date.

The at least one proposed sequence of actions may include at least one from among an income increase, an income decrease, a change in an amount of discretionary spending, a change in an amount of non-discretionary spending, an investment recommendation, and an obtaining of a loan.

The processor may be further configured to determine at least two sequences of proposed actions to be taken by the user, and to calculate a respective probability that the at least one financial goal is achievable based on the at least two sequences.

The processor may be further configured to cause the display to display, on a user interface, a result of the calculation of the probability that the at least one financial goal is achievable and a result of the determination of the at least one proposed sequence of actions to be taken by the user.

The processor may be further configured to: cause the display to display, on the user interface, a menu that includes a plurality of alternative financial goals; receive, from the user via the communication interface, at least one input that corresponds to a selection of at least one alternative financial goal from among the plurality of alternative financial goals; determine, based on a result of the application of the machine learning algorithm to the first information, at least one proposed sequence of actions to be taken by the user with respect to achieving the at least one alternative financial goal; calculate, based on a result of the application of the machine learning algorithm to the first information, a probability that the at least one alternative financial goal of the user is achievable; and cause the display to display, on the user interface, a respective result of each of the calculating and the determining with respect to the at least one alternative financial goal.

According to yet another aspect of the present disclosure, a method for providing a data-driven tool for individualized financial planning is provided. The method is implemented by at least one processor. The method includes: receiving, by the at least one processor from a user, first information that relates to the user, the first information including at least one financial goal of the user; applying, to the first information by the at least one processor, an artificial intelligence (AI) algorithm that uses a Monte Carlo tree search (MCTS) technique with respect to potential user actions; determining, by the at least one processor based on a result of the applying of the AI algorithm to the first information, at least one projected sequence of user actions with respect to achieving the at least one financial goal; and calculating, by the at least one processor based on a result of the applying of the AI algorithm to the first information, a probability that the at least one financial goal of the user is achievable.

The first information may further include at least one from among an age of the user, an education level of the user, a periodic income of the user, a non-periodic income of the user, a residence location, a periodic amount of discretionary spending, a periodic amount of non-discretionary spending, an outstanding loans amount, and a current savings amount.

The at least one financial goal may include at least one from among a change in an amount of income by a first projected date, a change in an amount of discretionary spending by a second projected date, a change in an amount of non-discretionary spending by a third projected date, a change in an amount of savings by a fourth projected date, a proposed purchase by a fifth projected date, and a proposed life event by a sixth projected date.

The potential user actions may include at least one from among an income increase, a change in an amount of discretionary spending, a change in an amount of non-discretionary spending, an investment recommendation, and an obtaining of a loan.

The determining of the at least one projected outcome may include determining at least two projected outcomes based on at least two sequences of potential user actions. The calculating of the probability that the at least one financial goal is achievable may include calculating a respective probability that the at least one financial goal is achievable based on the at least two sequences.

The method may further include displaying, by the at least one processor on a user interface, a result of the determining of the at least one projected outcome and a result of the calculating of the probability that the at least one financial goal is achievable.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a data-driven tool for individualized financial planning and navigation.

FIG. 4 is a flowchart of an exemplary process for implementing a method for providing a data-driven tool for individualized financial planning and navigation.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

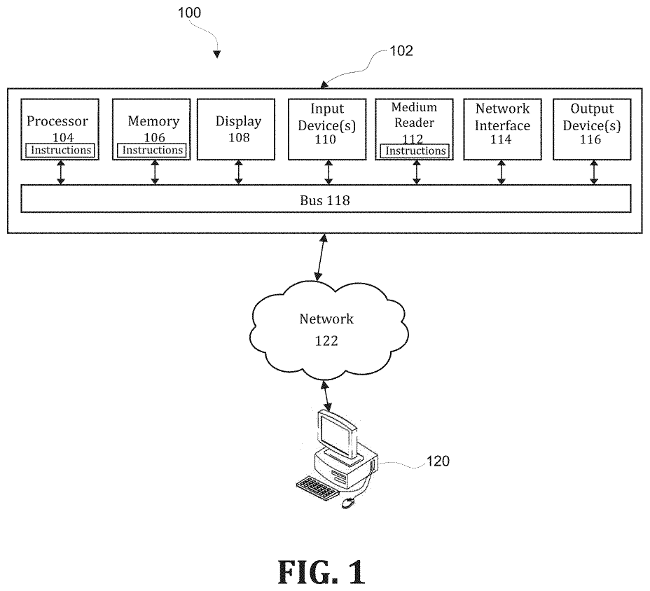

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a data-driven tool for individualized financial planning and navigation.

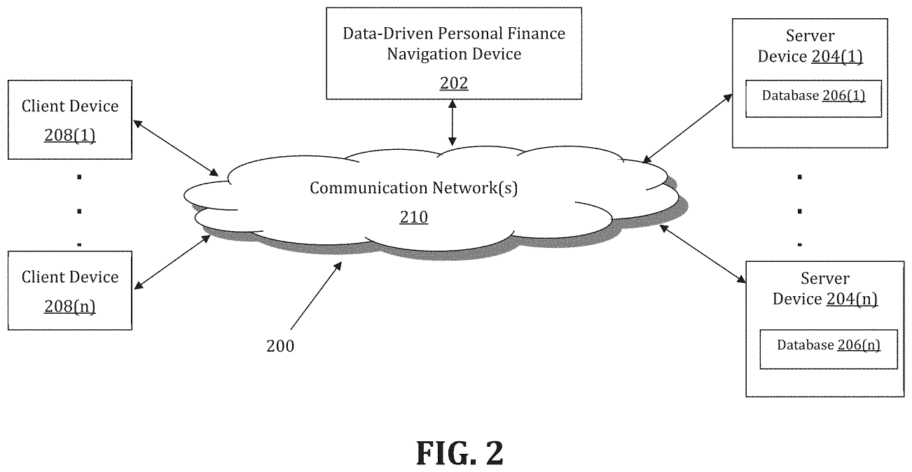

Referring to FIG. 2, a schematic of an exemplary network environment 200 for implementing a method for providing a data-driven tool for individualized financial planning and navigation is illustrated. In an exemplary embodiment, the method is executable on any networked computer platform, such as, for example, a personal computer (PC).

The method for providing a data-driven tool for individualized financial planning and navigation may be implemented by a Data-Driven Personal Finance Navigation (DDPFN) device 202. The DDPFN device 202 may be the same or similar to the computer system 102 as described with respect to FIG. 1. The DDPFN device 202 may store one or more applications that can include executable instructions that, when executed by the DDPFN device 202, cause the DDPFN device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DDPFN device 202 itself, may be located in virtual server(s) running in a cloud-based computing environment rather than being tied to one or more specific physical network computing devices. Also, the application(s) may be running in one or more virtual machines (VMs) executing on the DDPFN device 202. Additionally, in one or more embodiments of this technology, virtual machine(s) running on the DDPFN device 202 may be managed or supervised by a hypervisor.

In the network environment 200 of FIG. 2, the DDPFN device 202 is coupled to a plurality of server devices 204(1)-204(n) that hosts a plurality of databases 206(1)-206(n), and also to a plurality of client devices 208(1)-208(n) via communication network(s) 210. A communication interface of the DDPFN device 202, such as the network interface 114 of the computer system 102 of FIG. 1, operatively couples and communicates between the DDPFN device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DDPFN device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DDPFN devices that efficiently implement a method for providing a data-driven tool for individualized financial planning and navigation.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DDPFN device 202 may be a standalone device or integrated with one or more other devices or apparatuses, such as one or more of the server devices 204(1)-204(n), for example. In one particular example, the DDPFN device 202 may include or be hosted by one of the server devices 204(1)-204(n), and other arrangements are also possible. Moreover, one or more of the devices of the DDPFN device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DDPFN device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical data that relates to outcomes of financial actions for a large group of customers and data that relates to customer-specific financial planning information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DDPFN device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DDPFN device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DDPFN device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DDPFN device 202, the server devices 204(1)-204(n), or the client devices 208(1)-208(n), for example, may be configured to operate as virtual instances on the same physical machine. In other words, one or more of the DDPFN device 202, the server devices 204(1)-204(n), or the client devices 208(1)-208(n) may operate on the same physical device rather than as separate devices communicating through communication network(s) 210. Additionally, there may be more or fewer DDPFN devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

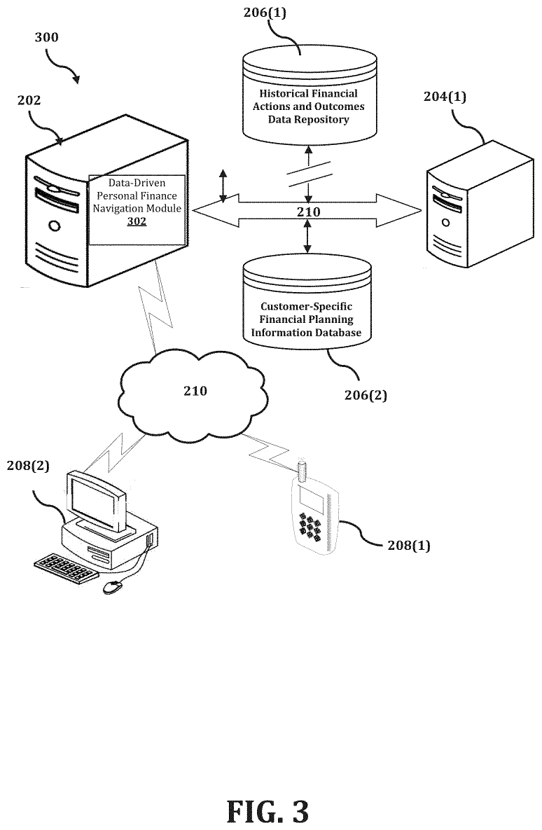

The DDPFN device 202 is described and illustrated in FIG. 3 as including a data-driven personal finance navigation module 302, although it may include other rules, policies, modules, databases, or applications, for example. As will be described below, the data-driven personal finance navigation module 302 is configured to implement a method for providing a data-driven tool for individualized financial planning and navigation.

An exemplary process 300 for implementing a mechanism for providing a data-driven tool for individualized financial planning and navigation by utilizing the network environment of FIG. 2 is illustrated as being executed in FIG. 3. Specifically, a first client device 208(1) and a second client device 208(2) are illustrated as being in communication with DDPFN device 202. In this regard, the first client device 208(1) and the second client device 208(2) may be “clients” of the DDPFN device 202 and are described herein as such. Nevertheless, it is to be known and understood that the first client device 208(1) and/or the second client device 208(2) need not necessarily be “clients” of the DDPFN device 202, or any entity described in association therewith herein. Any additional or alternative relationship may exist between either or both of the first client device 208(1) and the second client device 208(2) and the DDPFN device 202, or no relationship may exist.

Further, DDPFN device 202 is illustrated as being able to access a historical financial actions and outcomes data repository 206(1) and a customer-specific financial planning information database 206(2). The data-driven personal finance navigation module 302 may be configured to access these databases for implementing a method for providing a data-driven tool for individualized financial planning and navigation.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DDPFN device 202 via broadband or cellular communication. Of course, these embodiments are merely exemplary and are not limiting or exhaustive.

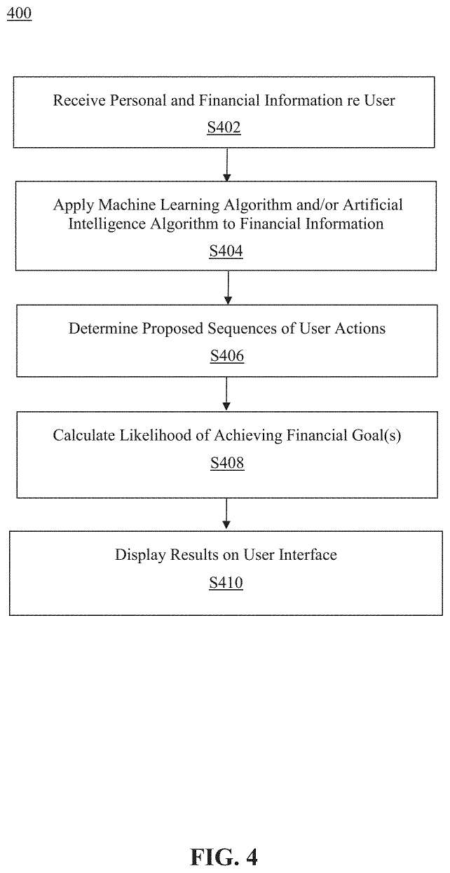

Upon being started, the data-driven personal finance navigation module 302 executes a process for providing a data-driven tool for individualized financial planning and navigation. An exemplary process for providing a data-driven tool for individualized financial planning and navigation is generally indicated at flowchart 400 in FIG. 4.

In process 400 of FIG. 4, at step S402, the data-driven personal finance navigation module 302 receives personal and financial information that pertains to a user. The personal and financial information may include, for example, any one or more of the following: an age of the user; an education level of the user; a current periodic (i.e., annual, monthly, or weekly) income of the user; non-periodic income of the user; a residence location; a current periodic amount of discretionary spending; a current periodic amount of non-discretionary spending; an amount of an outstanding loan; and a current amount of savings. In an exemplary embodiment, the current amount of savings may include any one or more of various forms of savings, such as, for example, investments, retirement savings accounts, retirement saving contributions, pension accruals, other sources of income, and other classes of assets. In an exemplary embodiment, the non-periodic income may include occasional income such as incentives, profit sharing, stock options, and/or any other types of income that are received on a non-periodic basis.

The personal and financial information may also include at least one financial goal of the user. In an exemplary embodiment, the financial goal may include an amount of increase or decrease in savings or income or discretionary spending or non-discretionary spending by a projected date; a proposed purchase by a projected date; and a retirement as of a projected date. For example, a financial goal may be to increase a savings amount by a particular amount or a particular percentage within a specified number of years. As another example, a financial goal may be to purchase a house or some other relatively expensive item within a particular amount of time, or to fund a college education that is expected to commence at a particular time. As yet another example, a person may have a goal of being able to retire with a specific minimum amount of savings by a certain date.

A first example of personal and financial information may include the following: Male, 20 years old, high school education, current annual income=$60,000, current annual discretionary spending=$35,000, current annual non-discretionary spending=$15,000, current savings=$10,000, and goal is to retire by age 67 with at least $1 million in savings. A second example of personal and financial information may include the following: Female, 35 years old, college degree, current annual income=$180,000, current annual discretionary spending=$65,000, current annual non-discretionary spending=$60,000, current savings=$150,000, mother of one child, planning to have a second child, and goals are to save $100,000 for children's college education and also to save $150,000 toward projected house purchase within 5 years.

At step S404, the data-driven personal finance navigation module 302 applies either or both of a machine learning algorithm and an artificial intelligence (AI) algorithm to the personal and financial data received in step S402. In an exemplary embodiment, the machine learning algorithm uses historical data that relates to financial outcomes based on various fact patterns. In an exemplary embodiment, the AI algorithm uses a Monte Carlo tree search (MCTS) technique with respect to potential user actions.

At step S406, the data-driven personal finance navigation module 302 uses a result of the application of the machine learning algorithm and/or the AI algorithm to determine potential sequences of actions to be taken by the user with respect to achieving the user's financial goal. In an exemplary embodiment, the potential user actions may include any one or more of an income increase, an income decrease, a change in an amount of discretionary spending, a change in an amount of non-discretionary spending (i.e., expenses that are required on a periodic basis, such as housing, food, and utilities), an investment recommendation (e.g., invest a certain amount in relatively high-risk securities and/or relatively low-risk securities), and an obtaining of a loan.

At step S408, the data-driven personal finance navigation module 302 uses a result of the application of the machine learning algorithm and/or the AI algorithm to calculate a likelihood that the financial goal is achievable. The calculated likelihood may be expressed as a probability that is greater than or equal to zero and less than or equal to one; i.e., if p=the calculated probability that the financial goal is achievable, then 0.00≤p≤1.00.

At step S410, the data-driven personal finance navigation module 302 displays results of the process 400 on a user interface. The results may include a listing of potential user actions and/or sequences of potential user actions and calculated probabilities of achieving the financial goal.

Accordingly, with this technology, an optimized process for providing a data-driven tool for individualized financial planning and navigation is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for providing a data-driven tool for individualized financial planning, the method being implemented by at least one processor, the method comprising:
receiving, by the at least one processor from a user, first information that relates to the user, the first information including at least one financial goal of the user;
applying, to the first information by the at least one processor, a machine learning algorithm that uses historical data that relates to financial outcomes;
determining, by the at least one processor based on a result of the applying of the machine learning algorithm to the first information, at least one proposed sequence of actions to be taken by the user with respect to achieving the at least one financial goal; and
calculating, by the at least one processor based on a result of the applying of the machine learning algorithm to the first information, a probability that the at least one financial goal of the user is achievable.

2. The method of claim 1, wherein the first information further includes at least one from among an age of the user, an education level of the user, a periodic income of the user, a non-periodic income of the user, a residence location, a periodic amount of discretionary spending, a periodic amount of non-discretionary spending, an outstanding loans amount, and a current savings amount.

3. The method of claim 1, wherein the at least one financial goal includes at least one from among a change in an amount of income by a first projected date, a change in an amount of discretionary spending by a second projected date, a change in an amount of non-discretionary spending by a third projected date, a change in an amount of savings by a fourth projected date, a proposed purchase by a fifth projected date, and a proposed life event by a sixth projected date.

4. The method of claim 1, wherein the at least one proposed sequence of actions includes at least one from among an income increase, an income decrease, a change in an amount of discretionary spending, a change in an amount of non-discretionary spending, an investment recommendation, and an obtaining of a loan.

5. The method of claim 1, wherein the determining of the at least one proposed sequence of actions to be taken by the user comprises determining at least two sequences of proposed actions to be taken by the user, and wherein the calculating of the probability that the at least one financial goal is achievable comprises calculating a respective probability that the at least one financial goal is achievable based on the at least two sequences.

6. The method of claim 1, further comprising displaying, by the at least one processor on a user interface, a result of the calculating of the probability that the at least one financial goal is achievable and a result of the determining of the at least one proposed sequence of actions to be taken by the user.

7. The method of claim 6, further comprising:
displaying, by the at least one processor on the user interface, a menu that includes a plurality of alternative financial goals;
receiving, by the at least one processor from the user, at least one input that corresponds to a selection of at least one alternative financial goal from among the plurality of alternative financial goals;
determining, by the at least one processor based on a result of the applying of the machine learning algorithm to the first information, at least one proposed sequence of actions to be taken by the user with respect to achieving the at least one alternative financial goal;
calculating, by the at least one processor based on a result of the applying of the machine learning algorithm to the first information, a probability that the at least one alternative financial goal of the user is achievable; and
displaying, on the user interface by the at least one processor, a respective result of each of the calculating and the determining with respect to the at least one alternative financial goal.

8. A computing apparatus for providing a data-driven tool for individualized financial planning, the computing apparatus comprising:
a processor;
a memory;
a display; and
a communication interface coupled to each of the processor, the memory, and the display,
wherein the processor is configured to:
receive, from a user via the communication interface, first information that relates to the user, the first information including at least one financial goal of the user;
apply, to the first information, a machine learning algorithm that uses historical data that relates to financial outcomes;
determine, based on a result of the application of the machine learning algorithm to the first information, at least one proposed sequence of actions to be taken by the user with respect to achieving the at least one financial goal; and
calculate, based on a result of the application of the machine learning algorithm to the first information, a probability that the at least one financial goal of the user is achievable.

9. The computing apparatus of claim 8, wherein the first information further includes at least one from among an age of the user, an education level of the user, a periodic income of the user, a non-periodic income of the user, a residence location, a periodic amount of discretionary spending, a periodic amount of non-discretionary spending, an outstanding loans amount, and a current savings amount.

10. The computing apparatus of claim 8, wherein the at least one financial goal includes at least one from among a change in an amount of income by a first projected date, a change in an amount of discretionary spending by a second projected date, a change in an amount of non-discretionary spending by a third projected date, a change in an amount of savings by a fourth projected date, a proposed purchase by a fifth projected date, and a proposed life event by a sixth projected date.

11. The computing apparatus of claim 8, wherein the at least one proposed sequence of actions includes at least one from among an income increase, an income decrease, a change in an amount of discretionary spending, a change in an amount of non-discretionary spending, an investment recommendation, and an obtaining of a loan.

12. The computing apparatus of claim 8, wherein the processor is further configured to determine at least two sequences of proposed actions to be taken by the user, and to calculate a respective probability that the at least one financial goal is achievable based on the at least two sequences.

13. The computing apparatus of claim 8, wherein the processor is further configured to cause the display to display, on a user interface, a result of the calculation of the probability that the at least one financial goal is achievable and a result of the determination of the at least one proposed sequence of actions to be taken by the user.

14. The computing apparatus of claim 13, wherein the processor is further configured to:
cause the display to display, on the user interface, a menu that includes a plurality of alternative financial goals;
receive, from the user via the communication interface, at least one input that corresponds to a selection of at least one alternative financial goal from among the plurality of alternative financial goals;
determine, based on a result of the application of the machine learning algorithm to the first information, at least one proposed sequence of actions to be taken by the user with respect to achieving the at least one alternative financial goal;
calculate, based on a result of the application of the machine learning algorithm to the first information, a probability that the at least one alternative financial goal of the user is achievable; and
cause the display to display, on the user interface, a respective result of each of the calculating and the determining with respect to the at least one alternative financial goal.

15. A method for providing a data-driven tool for individualized financial planning, the method being implemented by at least one processor, the method comprising:
receiving, by the at least one processor from a user, first information that relates to the user, the first information including at least one financial goal of the user;
applying, to the first information by the at least one processor, an artificial intelligence (AI) algorithm that uses a Monte Carlo tree search (MCTS) technique with respect to potential user actions;
determining, by the at least one processor based on a result of the applying of the AI algorithm to the first information, at least one projected sequence of user actions with respect to achieving the at least one financial goal; and
calculating, by the at least one processor based on a result of the applying of the AI algorithm to the first information, a probability that the at least one financial goal of the user is achievable.

16. The method of claim 15, wherein the first information further includes at least one from among an age of the user, an education level of the user, a periodic income of the user, a non-periodic income of the user, a residence location, a periodic amount of discretionary spending, a periodic amount of non-discretionary spending, an outstanding loans amount, and a current savings amount.

17. The method of claim 15, wherein the at least one financial goal includes at least one from among a change in an amount of income by a first projected date, a change in an amount of discretionary spending by a second projected date, a change in an amount of non-discretionary spending by a third projected date, a change in an amount of savings by a fourth projected date, a proposed purchase by a fifth projected date, and a proposed life event by a sixth projected date.

18. The method of claim 15, wherein the potential user actions include at least one from among an income increase, an income decrease, a change in an amount of discretionary spending, a change in an amount of non-discretionary spending, an investment recommendation, and an obtaining of a loan.

19. The method of claim 15, wherein the determining of the at least one projected outcome comprises determining at least two projected outcomes based on at least two sequences of potential user actions, and wherein the calculating of the probability that the at least one financial goal is achievable comprises calculating a respective probability that the at least one financial goal is achievable based on the at least two sequences.

20. The method of claim 15, further comprising displaying, by the at least one processor on a user interface, a result of the determining of the at least one projected outcome and a result of the calculating of the probability that the at least one financial goal is achievable.
